(19) United States
(12) Patent Application Publication
(10) Pub. No.: US 2021/0351977 A1
(43) Pub. Date: Nov. 11, 2021

(54) SMART COLLABORATION BETWEEN COMPUTING DEVICES FOR ENSURING A USER RECEIVES SCHEDULED NOTIFICATIONS

(71) Applicant: QUALCOMM Incorporated, San Diego, CA (US)

(72) Inventors: Vinaya Kumara T.V., Bengaluru (IN); Suraj CHINCHOLIMATH, Bengaluru (IN)

(21) Appl. No.: 16/866,806

(22) Filed: May 5, 2020

(51) Int. Cl. H04L 12/24

(52) U.S. Cl. CPC H04L 41/0803

(57) ABSTRACT

Methods executed by a processor of user equipment for ensuring a user receives scheduled notifications are disclosed. Exemplary implementations may determine whether a notification is unlikely to be received by a user of the user equipment based on a state of the user equipment, and configuring a remote computing device to perform a notification function on behalf of the user equipment in response to determining that the notification is unlikely to be received by the user. Configuring the remote computing device may include transmitting a delegation message configured to cause the remote computing device to perform the notification function on behalf of the user equipment or implementing call-forwarding from the user equipment to the remote computing device.

### BACKGROUND

Computing devices like smart phones and other so-called “smart” devices are becoming ubiquitous. Such computing devices are often used for important tasks/functions, such as making/receiving communications, sounding alarms/reminders, providing calendars reminders, providing assistant functions, and other operations. However, often the settings or operational state of mobile smart devices make it likely that a user thereof will miss notifications.

For example, mobile smart devices rely on batteries that need regular charging, and if a user does not keep their mobile smart device charged, they may miss important calls, alarms, notifications, and/or assistant routines. Also, users may miss notifications when their mobile smart device is inadvertently left in silent mode. Even though silent mode notifications may cause the mobile smart device to vibrate and/or flash a light, such notifications may still be easily missed. In contrast, although many home smart devices, which are computing devices, like Google Home® (Google, LLC, Mountain View, Calif., USA), Amazon Echo® (Amazon.com, Inc., Seattle, Wash., USA), smart televisions, smart refrigerators, other smart appliances, etc., perform many of the same tasks as mobile smart devices, those home smart devices tend to be connected to a regular supply of power through a power supply outlet and may not include a silent mode.

### SUMMARY

Various aspects include methods and computing devices implementing the methods executed by a processor of user equipment for ensuring a user receives scheduled notifications. Various aspects include methods that may be implemented on user-equipment, such as a computing device having a transceiver, a memory, and a processor coupled to the transceiver and the memory. Various aspects may include determining whether a notification is unlikely to be received by a user of the user equipment based on a state of the user equipment, and configuring a remote computing device to perform a notification function on behalf of the user equipment in response to determining that the notification is unlikely to be received by the user.

In some aspects, configuring the remote computing device to perform a notification function on behalf of the user equipment may include transmitting a delegation message configured to cause the remote computing device to perform the notification function on behalf of the user equipment. In some aspects, configuring the remote computing device to perform a notification function on behalf of the user equipment may include implementing call-forwarding from the user equipment to the remote computing device.

Some aspects may include determining whether a communication link is available to one or more remote computing devices in response to determining that the notification is unlikely to be received by the user, transmitting an inquiry to determine whether a selected computing device can perform the notification function on behalf of the user equipment in response to determining that the communication link is available to one or more remote computing devices, and receiving an acceptance message from the selected computing device indicating the selected computing device can perform the notification function on behalf of the user equipment, in which configuring the remote computing device to perform the notification function on behalf of the user equipment may be performed further in response to receiving the acceptance message from the selected computing device. Some aspects may include determining whether the selected computing device is a power-connected computing device, in which configuring a remote computing device to perform a notification function on behalf of the user equipment in response to determining that the notification is unlikely to be received by the user may include configuring the selected computing device to perform the notification function on behalf of the user equipment in response to determining that the notification is unlikely to be received by the user and that the selected computing device is a power-connected computing device. Some aspects may include determining whether the selected computing device has sufficient battery level, in which case configuring a remote computing device to perform a notification function on behalf of the user equipment in response to determining that the notification is unlikely to be received by the user may include configuring the selected computing device to perform the notification function on behalf of the user equipment in response to determining that the selected computing device has a sufficient battery level.

Some aspects may include determining whether a battery charge state of the user equipment is at or below a low-level threshold, and determining that the notification is unlikely to be received by the user of the user equipment in response to determining that the battery charge state of the user equipment is at or below the low-level threshold.

Some aspects may further include determining whether the user equipment is in a silent mode, and determining that the notification is unlikely to be received by the user of the user equipment in response to determining that the user equipment is in the silent mode. Some aspects may further include determining whether the user equipment remained inactive during a predetermined number of notifications, and determining that the notification is unlikely to be received by the user of the user equipment in response to determining that the user equipment remained inactive during the predetermined number of notifications.

Some aspects may further include determining whether the user equipment is within a pre-notification period before a scheduled notification, in which configuring the remote computing device to perform the notification function may be performed further in response to determining that the user equipment is within the pre-notification period.

Some aspects may further include determining whether an updated state of the user equipment indicates the notification is now likely to be received by the user of the user equipment, and transmitting a revocation message to the remote computing device indicating that the remote computing device should not perform the notification function on behalf of the user equipment in response to determining that the updated state of the user equipment indicates the notification is now likely to be received by the user of the user equipment.

Further aspects include a user equipment computing device including a transceiver, a memory, and a processor configured with processor-executable instructions to perform operations of any of the methods summarized above. Further aspects include a non-transitory processor-readable storage medium having stored thereon processor-executable software instructions configured to cause a processor to perform operations of any of the methods summarized above. Further aspects include a processing device for use in a computing device and configured to perform operations of any of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIGS. 1A-1C are schematic diagrams illustrating a computing device ensuring a user receives scheduled notifications in accordance with various embodiments.

FIG. 2 is a block diagram illustrating components of an example system in a package for use in a computing device in accordance with various embodiments.

FIG. 3 shows a component block diagram of an example system configured for executed by a processor of user equipment for ensuring a user receives scheduled notifications.

FIGS. 4A, 4B, 4C, 4D, 4E, 4F, 4G, 4H, 4I, and/or 4J show process flow diagrams of example methods for executed by a processor of user equipment for ensuring a user receives scheduled notifications according to various embodiments.

FIG. 5 is a component block diagram of a network computing device suitable for use with various embodiments.

FIG. 6 is a component block diagram of a wireless device suitable for use with various embodiments.

### DETAILED DESCRIPTION

Various aspects will be described in detail with reference to the accompanying drawings. Wherever possible, the same reference numbers will be used throughout the drawings to refer to the same or like parts. References made to particular examples and embodiments are for illustrative purposes and are not intended to limit the scope of the various aspects or the claims.

Various embodiments provide methods executed by a processor of a user equipment for ensuring a user receives scheduled notifications in situations in which the user equipment is in a condition that would prevent such notifications from being received. Various embodiments may determine whether a scheduled notification is unlikely to be received by a user of the user equipment based on a state of the user equipment. In addition, some embodiments may configure a remote computing device to perform a notification function on behalf of the user equipment in response to determining that the scheduled notification is unlikely to be received by the user.

As used herein, the term “notification” refers to functions executed by elements of a computing device to inform a user of something. For example, notifications may include warning sounds that are associated with incoming calls, messages, alarms (e.g., timed alerts, calendar events, or other reminders), alerts (e.g., from applications), and/or assistant routines.

As used herein, the term “computing device” refers to an electronic device equipped with at least a processor, communication systems, and memory configured with a contact database. Also, as used herein the term “user equipment” refers to a particular computing device from which a user may receive notifications. Computing devices, including the user equipment, may include any one or all of cellular telephones, smartphones, portable computing devices, personal or mobile multi-media players, laptop computers, tablet computers, 2-in-1 laptop/table computers, smartbooks, ultrabooks, palmtop computers, wireless electronic mail receivers, multimedia Internet-enabled cellular telephones, wearable devices including smart watches, smart glasses, augmented/virtual reality devices, entertainment devices (e.g., wireless gaming controllers, music and video players, satellite radios, etc.), and similar electronic devices that include a memory, wireless communication components and a programmable processor. In various embodiments, computing devices may be configured with memory and/or storage. Additionally, computing devices referred to in various example embodiments may be coupled to or include wired or wireless communication capabilities implementing various embodiments, such as network transceiver(s) and antenna(s) configured to communicate with wireless communication networks.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

Although most users of mobile computing devices, like cellular telephones, try to be diligent about keeping their mobile computing device sufficiently charged, numerous circumstances arise in which users find their mobile computing device with a very low or even no charge. With insufficient charge, mobile computing devices may be incapable of performing basic functions, which may cause the user to miss calls and/or notifications. In addition, although the “silence” or mute function on a mobile computing device may be helpful to avoid disturbing others, that same feature is often the cause of missed calls and or notifications.

Various embodiments enable user equipment to ensure a user receives scheduled notifications from user equipment (i.e., the mobile computing device of a user). In particular, various embodiments may detect when a state of the user equipment makes it unlikely that the user will receive notifications configured to be issued from the user equipment. The state of the user equipment indicates a particular condition that the user equipment is in at a specific time. For example, when a battery of the user equipment has reached a low-level threshold the user equipment may end up having insufficient charge to sound alarms for calendar events or reminders, and/or notify the user of incoming calls or messages. Similarly, if the user equipment is in silent mode, the user may not notice vibrations or flashing lights from the user equipment, thus causing the user to miss alarms for calendar events or reminders, and/or notifications to the user of incoming calls or messages.

Once a processor of the user equipment detects that the state of the user equipment makes it unlikely that the user will receive notifications from the user equipment, the user equipment may configure a remote computing device to perform notification functions on behalf of the user equipment. In this way, the remote computing device may take over notification functions like ringing for incoming calls, providing alarms, calendar alerts, and/or assistant routines. Alternatively, if the user has not responded to notifications (e.g., by declining a call, dismissing an alarm, flipping the phone so the screen-side faces down, placing the phone in a pocket, or does nothing) more than a predetermined number of times (e.g., one or more missed calls or persistent alarms sounding), the user equipment may recognize the circumstance and configure a remote computing device to perform notification functions on behalf of the user equipment. Configuring the remote computing device may use wireless communication links (e.g., Bluetooth, Wi-Fi, Narrowband Internet of Things (NB-IoT), etc.).

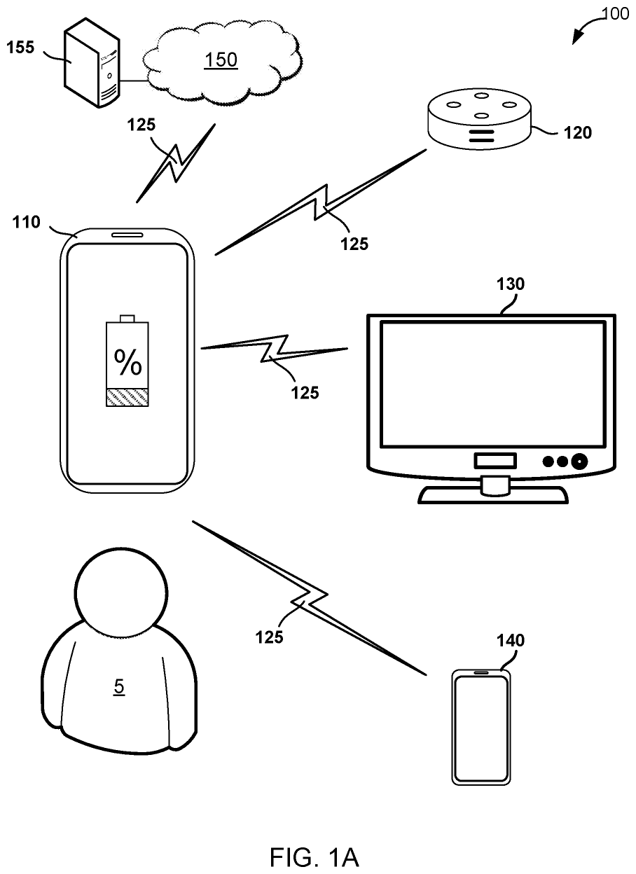

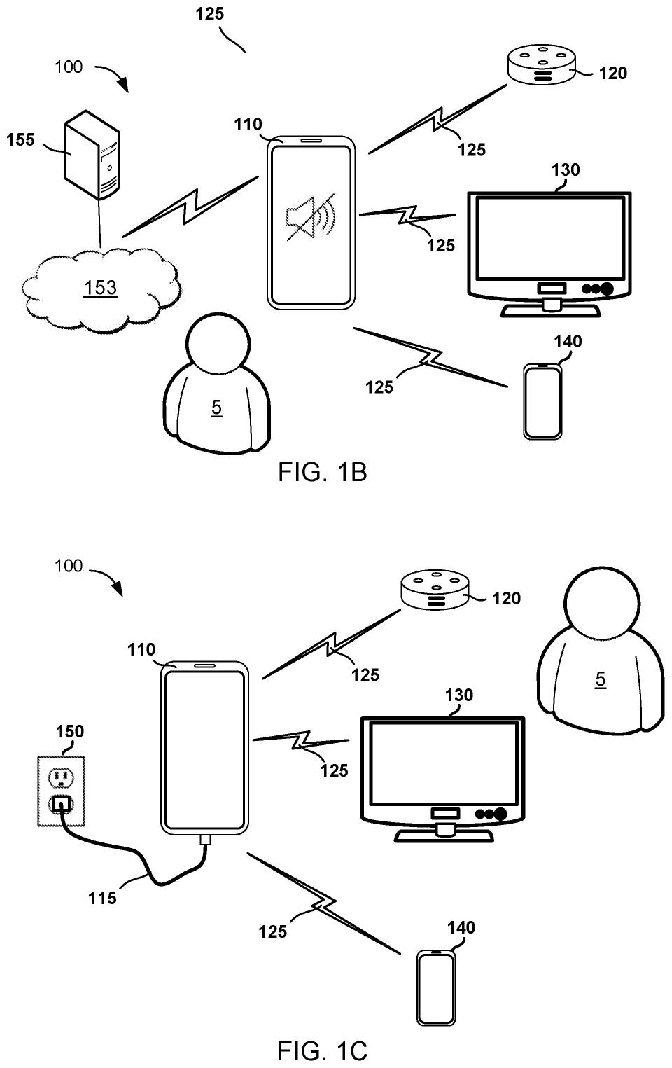

FIGS. 1A-1C illustrate a schematic diagram of an environment 100 containing user equipment 110 (i.e., a computing device used by a user 5) suitable for implementing various embodiments. The environment 100 includes the user 5 associated with the user equipment 110, in the form of a cellular telephone. In addition, the environment 100 includes remote computing devices, particularly home smart devices including a smart speaker 120, a smart television 130, and another mobile computing device 140. The smart speaker 120 is a device that enables users (e.g., user 5) to speak voice commands to interact with services through an automated and/or virtual assistant. The smart television 130, also known as a connected TV, is a traditional television set with integrated Internet and interactive features, which allow users to stream music and videos, browse the internet, view photos, and receive notifications (i.e., messages and/or alerts). The other mobile computing device 140 may be the same is similar to the user equipment 110 of the user 5. Various embodiments may include a fewer or greater number of remote computing devices, including one or more types of computing device not shown in the environment 100.

Each of FIGS. 1A-1C include the user equipment 110, which may be configured to communicate with remote computing devices through one or more wireless connections 125 (e.g., Wi-Fi, Bluetooth, cellular, etc.), which may be supported by a wireless local area network router (not shown), such as a Wi-Fi wireless router, or a cellular network base station. In addition to local computing devices within the vicinity of the user equipment 110 (e.g., the smart speaker 120, the smart television 130, another mobile computing device 155, etc.), the user equipment 110 may be configured to reach a more remote computing devices (e.g., a server 155) through a wireless network 153, such as a Wi-Fi local area wireless network router coupled to the Internet or a cellular wireless communication network.

FIG. 1A illustrates the user equipment 110 with an extremely low battery. In accordance with various embodiments, once a battery charge state of the computing device reaches or goes below a low-level threshold, a processor of the user equipment 110 may initiate procedures configured to ensure the user 5 receives one or more notifications. The battery charge state is the level of charge of an electric battery relative to its capacity. The units of battery charge state may be provided as a percentage (i.e., 0%=empty; 100%=fully charged). The low-level threshold may be a predetermined level that reflects a battery charge state that is insufficient or will be insufficient to provide one or more notifications to a user. For example, the low-level threshold may be 2%-5% charge remaining in the battery of the user equipment 110. Once the battery charge state reaches or goes below the low-level threshold, there may not be sufficient battery charge to conduct a phone call or even receive regular incoming calls or messages. Also, without the user equipment 110 being charged, any notifications scheduled to occur in the future will occur when an update to the state of the user equipment 110 reflects an even lower battery charge state. Thus, in various embodiments, a notification is considered unlikely to be received by the user 5 of the user equipment 110 (i.e., the user equipment), based on a state of the user equipment 110, once the battery charge state reaches or goes below the low-level threshold.

In one aspect of the present disclosure, the procedures configured to ensure the user 5 receives one or more notifications may include configuring a remote computing device to perform a notification function on behalf of the user equipment 110 in response to determining that a notification is unlikely to be received by the user 5. For example, the processor may use a transceiver of the user equipment 110 to transmit a delegation message, via one or more wireless connections 125. The delegation message may be configured to cause a remote computing device (e.g., the smart speaker 120, the smart television 130, another mobile computing device 140) to perform the notification function on behalf of the user equipment.

In some embodiments, a processor of the user equipment 110 may attempt to discover communication links available to one or more remote computing devices. In this way, the processor may determine whether a communication link is available to one or more remote computing devices in response to determining that a notification is unlikely to be received by the user. In some embodiments, the processor of the user equipment 110 may transmit an inquiry to a selected computing device to determine whether that selected computing device can perform the notification function on behalf of the user equipment. In some embodiments, the processor of the user equipment 110 may receive an acceptance message from the selected computing device indicating the selected computing device can perform the notification function on behalf of the user equipment 110. In some embodiments, configuring the remote computing device to perform the notification function on behalf of the user equipment may be further in response to receiving the acceptance message from the remote computing device. In addition, or alternatively, the processor of the user equipment 110 may determine whether the selected computing device is a power-connected computing device (i.e., a computing device connected to a recharging power source) to ensure that the responsibility of performing notification functions on behalf of the user equipment is assigned to a device that is deemed fit to do so, such as a power-connected device or non-power-connected device that has battery levels that meet a threshold (i.e., sufficient battery charge).

In some embodiments, not all notifications need to be treated equally. Some notifications or types of notifications may be characterized as important notifications, while others are characterized as unimportant notifications. The user 5 may not want or need all types of notifications to be handled in the same way. Thus, the configuration of a remote computing device to perform notification functions on behalf of the user equipment 110 (i.e., “remote computing device notification functions”) may be limited to important notifications. The user equipment may have default and/or adjustable settings that designate which types of notifications to treat as important. For example, the user may designate only incoming phone calls as important, thus desiring call be forwarded to a remote computing device if they are likely to be missed. In fact, the user may even limit the remote computing device notification functions to only occur after a number of rings from an incoming call have been unanswered. As another example, the user may designate only scheduled notifications (e.g., a wake-up alarm) as important, so that if the user ignores the scheduled notification too long, a home smart speaker will start emitting the alarm, which lets the user know that scheduled notification has been ignored too long. Many types of notifications may be designated as important for purposes of providing remote computing device notification functions. Also, as a further alternative, multiple levels or types of remote computing device notification function may be provided. In this way, different procedures may be followed for different types of notifications. For example, incoming call may require a delay before forwarding, while scheduled notifications are handled through the remote computing device notification function immediately.

Some embodiments may consider when scheduled notifications (e.g., reminders, alerts, or alarms) are programmed to happen before setting up remote computing device notification functions. For example, if a notification is not scheduled to occur until the next day or later, setting up remote computing device notification functions may be premature. Similarly, if a notification is scheduled to occur very soon (e.g., within minutes), there may be no need to set up remote notification functions. Thus, the processor of the user equipment may consider whether a period before a scheduled notification meets a pre-notification period threshold corresponding to a predetermined window of time. In this way, if the length of time before a scheduled notification is programmed to occur is either too short or too long, a remote computing device will not be configured to perform notification functions on behalf of the user equipment 110. In particular, the processor of the user equipment 110 may determine whether a scheduled notification is even programmed to occur. If so, the processor may further determine whether a period before the scheduled notification meets the pre-notification period threshold before configuring a remote computing device to perform remote computing device notification functions. In some embodiments of the method, the scheduled notification may be one of an alarm, a reminder, a calendar event, an application alert, or a message alert.

FIG. 1B illustrates the user equipment 110 set in a silence mode. As used herein, the expression “silent mode” refers to a setting available on mobile computing devices that, when activated, disables the ringtones or audible sounds associated with notifications. Unlike an “airplane mode,” the silent mode still allows the device to receive and send calls and messages. In accordance with various embodiments, once a processor determines the user equipment 110 is in the silence mode, a processor of the user equipment 110 may initiate procedures configured to ensure the user 5 receives notifications. Alternatively, the processor may wait to initiate procedures configured to ensure the user 5 receives notifications until after the user equipment 110 remained inactive during a predetermined number of notifications. In some embodiments, the user equipment 110 remaining inactive during the predetermined number of notifications is an indication that the user did unlikely receive the notifications. For example, if two consecutive incoming calls go unanswered, the processor of the user equipment 110 may initiate call forwarding such that the other mobile computing device 140 receives incoming calls and messages on behalf of the user equipment 110. The user equipment 110 may initiate call forwarding by sending a call-forwarding registration request or similar message to a communication service provider (e.g., server 155). As another example, if the user equipment 110 receives no user input while during a predetermined period (i.e., a period of inactivity), while in silent mode (e.g., during a series of vibrations from an alarm going off), the user equipment 110 may configure the smart speaker 120 to emit an audible alarm for the user 5 to hear.

FIG. 1C illustrates the user equipment 110 now connected via a power cord 115 to a power source 150 (e.g., an electrical outlet). In accordance with various embodiments, the processor of the user equipment 110 may immediately detect when the user equipment is connected to a power source (e.g., 150) and revoke the delegation of notification functions currently be handled by the remote computing device (e.g., 120, 130, 140). Being connected to the power source 150 makes it much more likely that the user will receive notifications. In this way, the processor of the user equipment 110 may determine whether an updated state of the user equipment, such as one reflecting that power is currently being supplied by the power source 150, indicates the scheduled notification is now likely to be received by the user of the user equipment. In some embodiments of the method, the processor of the user equipment 110 may use a transceiver to transmit a revocation message to the remote computing device, indicating that the remote computing device should no longer perform the notification function on behalf of the user equipment 110 in response to determining that the updated state of the user equipment 110 indicates that the user equipment 110 is currently connected to a power source. Alternatively, the battery of the user equipment may need to be recharged to a requisite minimum level of battery charge (e.g., 10%-15%), before the revocation message is transmitted to the remote computing device. Requiring a requisite minimum level of better charge before canceling remote notifications may prevent having to reestablish the remote computing device notification function in the event the power supply is disconnected or interrupted shortly after being connected. For example, if the user equipment 110 configured a remote computing device (e.g., 120, 130, 140) to perform a notification function just prior to the user equipment 110 powering off completely, and the user equipment 110 is subsequently connected to a power supply, once the user equipment 110 is sufficiently charged, the user equipment 110 may transmit a revocation message.

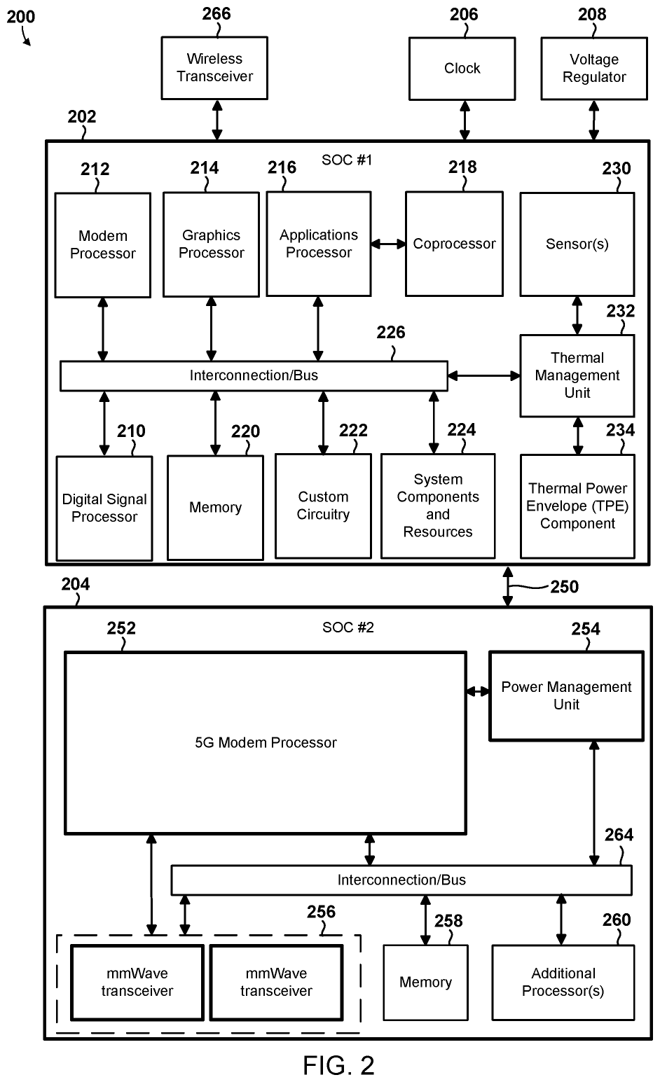

Various embodiments may be implemented using a number of single processor and multiprocessor computer systems, including a system-on-chip (SOC) or system in a package (SIP). FIG. 2 illustrates an example computing system or SIP 200 architecture that may be used in a computing device, such as the user equipment (e.g., 110) implementing the various embodiments.

With reference to FIGS. 1 and 2, the illustrated example SIP 200 includes a two SOCs 202, 204, a clock 206, a voltage regulator 208, and a wireless transceiver 266. In some embodiments, the first SOC 202 operates as central processing unit (CPU) of the wireless device that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wave length (e.g., 28 GHz mmWave spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, custom circuitry 222, system components and resources 224, an interconnection/bus module 226, one or more sensors 230 (e.g., thermal sensors, motion sensors, proximity sensors, a multimeter, etc.), a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (e.g., clock 206, voltage regulator 208) may be shared by two or more of the internal SOC processors/cores.

In addition to the example SIP 200 discussed above, various embodiments may be implemented in a wide variety of computing systems, which may include a single processor, multiple processors, multicore processors, or any combination thereof.

As used herein, the terms “component,” “system,” “unit,” “module,” and the like include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

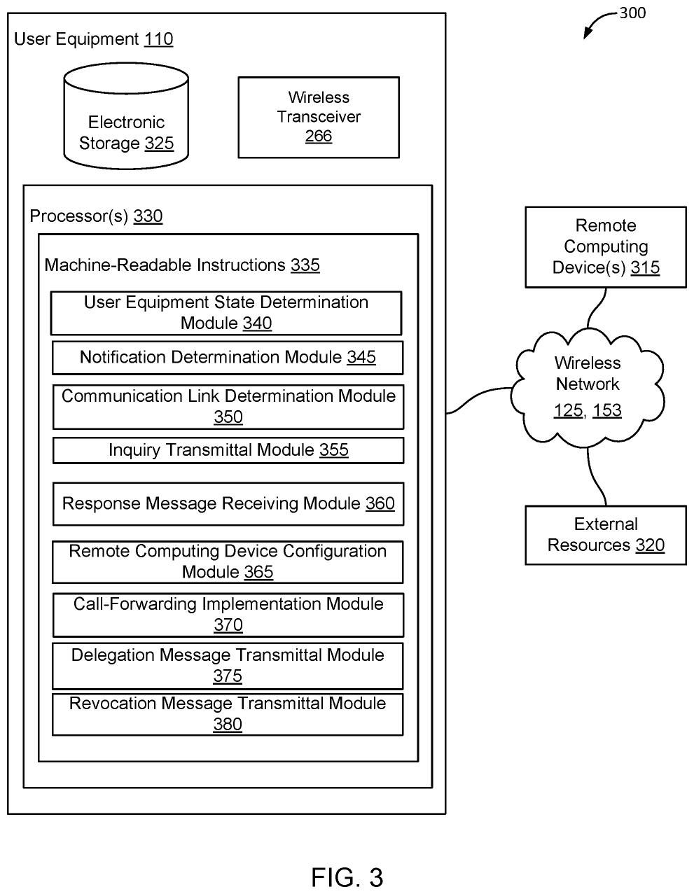

FIG. 3 is a component block diagram illustrating a system 300 configured for ensuring a user receives notifications executed by a processor of a computing device in accordance with various embodiments. With reference to FIGS. 1-3, the system 300 may include the user equipment 110 and one or more remote computing device(s) 315 (e.g., 120, 130, 140 in FIGS. 1A-1C). The user equipment 110 may be configured to communicate with remote computing device(s) 315 and/or external resources 320 via a wireless network 125, 153, such as a Wi-Fi local area wireless network router (which may be coupled to the Internet) or a cellular wireless communication network.

The user equipment 110 may include electronic storage 325, one or more processors 330, a wireless transceiver 266, and other components. The user equipment 110 may include communication lines, or ports to enable the exchange of information with a network and/or other computing platforms. Illustration of the user equipment 110 in FIG. 3 is not intended to be limiting. The user equipment 110 may include a plurality of hardware, software, and/or firmware components operating together to provide the functionality attributed herein to the user equipment 110.

Electronic storage 325 may comprise non-transitory storage media that electronically stores information. The electronic storage media of electronic storage 325 may include one or both of system storage that is provided integrally (i.e., substantially non-removable) with the user equipment 110 and/or removable storage that is removably connectable to the user equipment 110 via, for example, a port (e.g., a universal serial bus (USB) port, a firewire port, etc.) or a drive (e.g., a disk drive, etc.). Electronic storage 325 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 325 may include one or more virtual storage resources (e.g., cloud storage, a virtual private network, and/or other virtual storage resources). Electronic storage 325 may store software algorithms, information determined by processor(s) 330, information received from the user equipment 110, information received from remote platform(s) 304, and/or other information that enables the user equipment 110 to function as described herein.

Processor(s) 330 may be configured to provide information processing capabilities in the user equipment 110. As such, processor(s) 330 may include one or more of a digital processor, an analog processor, a digital circuit designed to process information, an analog circuit designed to process information, a state machine, and/or other mechanisms for electronically processing information. Although processor(s) 330 is shown in FIG. 3 as a single entity, this is for illustrative purposes only. In some embodiments, processor(s) 330 may include a plurality of processing units. These processing units may be physically located within the same device, or processor(s) 330 may represent processing functionality of a plurality of devices operating in coordination.

The user equipment 110 may be configured by machine-readable instructions 335, which may include one or more instruction modules. The instruction modules may include computer program modules. In particular, the instruction modules may include one or more of a user equipment state determination module 340, a notification determination module 345, a communication link determination module 350, an inquiry transmittal module 355, a response message receiving module 360, a remote computing device configuration module 365, a call-forwarding implementation module 370, a delegation message transmittal module 375, a revocation message transmittal module 380, and/or other instruction modules.

The user equipment state determination module 340 may be configured to determine one or more states of the user equipment (e.g., 110). By way of non-limiting example, the state or each state of the user equipment indicates a particular condition that the user equipment is in at a specific time, including but not limited to a battery level, an operating mode, and/or a level of activity (or inactivity) of the user equipment. A processor (e.g., 210, 212, 214, 216, 218, 252, 260) of the user equipment may use one or more sensors (e.g., 230) to determine one or more elements that contribute to the state of the user equipment. For example, the processor may receive measurements from a multimeter or the like, built into the user equipment, and configured to measure the battery charge state of a battery of the user equipment. By monitoring the battery charge state, the processor may determine when the battery charge state has reached a low-level threshold, which may cause the processor to determine that a notification is unlikely to be received by a user.

Additionally, the user equipment may have one or more operating modes, such as a silent mode, an airplane mode, a heightened-alert mode, or others. Unlike conventional silent and airplane modes, which limit, restrict, or eliminate notifications provided by the user equipment, the heightened-alert mode may attempt to increase the likelihood that a user receives notifications. In the heightened-alert mode, notifications may not only be output from the user equipment in the conventional manner or even with volume increased, but additionally the processor may configure remote computing devices to simultaneously perform additional notification functions on behalf of the user equipment as well. The processor of the user equipment may receive an indication or otherwise detect when the user equipment is placed in or taken out of a particular operating mode.

Further, the user equipment state determination module 340 may be configured to determine a level of activity (or inactivity) of the user equipment. With regard to activity of the user equipment, the user equipment state determination module 340 may be particularly focused on user inputs. Thus, a period in which the user does not interact with the user equipment is considered a period of inactivity. Periods of inactivity, particularly when one or more notifications are output by the user equipment may suggest the user is either ignoring or unaware of the notifications.

The state of the user equipment may indicate a notification is unlikely to be received by the user of the user equipment in response to determining that the user equipment is inactive and has been inactive for more than the dormant-period threshold.

The user equipment state determination module 340 may be configured to determine the one or more states of the user equipment by actively checking settings and/or sensor readings or receiving indications of such settings and/or sensor readings, which may occur regularly or at some other intervals. Once a state of the user equipment is determined, any subsequent change to that state will be considered an updated state of the user equipment.

The notification determination module 345 may be configured to determine whether a notification is unlikely to be received by a user of the user equipment based on the state of the user equipment (i.e., determined by the user equipment state determination module 340). By way of non-limiting example, the notifications may be one or more of sounds, lights, screen display functions, vibrations, etc. from incoming calls, messages, alarms, alerts, and/or assistant routines. A processor (e.g., 210, 212, 214, 216, 218, 252, 260) of the user equipment may access the electronic storage 325 to determine which notifications, and/or which type of notifications, the notification determination module 345 needs to consider. For example, user settings stored in the electronic storage 325 may indicate that the user has selected to forego remote computing device notification functions related to all incoming calls or messages; meaning features like call-forwarding would not be implemented. Thus, the notification determination module 345 may initially determine whether there are any notifications under consideration. If no alarms, reminders, calendar events, or other scheduled notifications are pending, and if no notifications related to incoming calls or messages are being delegated to remote computing devices, the notification determination module 345 may determine that nothing needs to be done to implement remote computing device notification functions. Alternatively, if unplanned notifications (e.g., from incoming calls or messages) and/or scheduled notifications are potentially being delegated to remote computing devices, the notification determine module 345 may determine that a notification is unlikely to be received by a user of the user equipment based on a state of the user equipment.

Additionally, if a scheduled notification is programmed to occur (i.e., in the future) the notification determination module 345 may determine whether a period before the scheduled notification meets a pre-notification period threshold. The pre-notification period threshold may be a window of time, extending from a first time, relatively close to the current time, to a second time that is later than the first time but not so remote that it does not need to be considered in this charging cycle (e.g., before the user equipment is charged in its regular daily charging cycle).

The communication link determination module 350 may be configured to determine whether a communication link is available to one or more remote computing devices in response to determining that a notification is unlikely to be received by the user. By way of non-limiting example, the processor (e.g., 210, 212, 214, 216, 218, 252, 260) of the user equipment may use one or more transceivers (e.g., 256) for detecting available wireless connections 125 (e.g., Wi-Fi, Bluetooth, cellular, etc.). Also, the communication link determination module 350 may be configured to determine whether a detected communication link is available to a power-connected computing device. As used herein, a “power-connected computing device” refers to a computing device connected to a recharging power source.

Inquiry transmittal module 355 may be configured to transmit an inquiry message to one or more remote computing devices to determine whether a remote computing device can perform a remote computing device notification function on behalf of the user equipment. By way of non-limiting example, the processor (e.g., 210, 212, 214, 216, 218, 252, 260) of the user equipment may use one or more transceivers (e.g., 256) to transmit the inquiry message over available wireless connections (e.g., 125). The inquiry message(s) may be configured to elicit a response from each connected remote computing devices indicating whether that remote computing device is capable of performing remote computing device notification functions on behalf of the user equipment.

The response message receiving module 360 may be configured to receive an acceptance or declination message from one or more remote computing devices. The acceptance messages may indicate that remote computing device is capable of performing remote computing device notification functions on behalf of the user equipment. In contrast, the declination messages may indicate that remote computing device is not capable of performing remote computing device notification functions on behalf of the user equipment. By way of non-limiting example, the processor (e.g., 210, 212, 214, 216, 218, 252, 260) of the user equipment may use one or more transceivers (e.g., 256) to receive the acceptance and/or declination messages over available wireless connections (e.g., 125).

Remote computing device configuration module 365 may be configured to configure a remote computing device to perform a notification function on behalf of the user equipment in response to determining that the notification is unlikely to be received by the user. By way of non-limiting example, the processor (e.g., 210, 212, 214, 216, 218, 252, 260) of the user equipment may use one or more transceivers (e.g., 256) to transmit instructions and/or messages used by the remote computing device to perform remote computing device notification functions on behalf of the user equipment.

The remote computing device configuration module 365 may use application program interfaces (APIs), which may be transmitted to remote computing devices, providing instructions for Remote Computing Device Notification Functions (RCDNF) that should be performed or no longer performed. Table 1, below, includes some examples of APIs that may be used to configure remote computing devices to perform the notification functions. Such APIs may be communicated over wireless connections (e.g., 125) and are agnostic to the connecting technology.

TABLE 1

| | Android-based | | |
|---|---|---|---|
| | devices (using | Alexa-based | Devices which conform to |
| RCDNF | gRPC based APIs) | devices | OpenThread platform |
| Set Alarm | EmbeddedAssistant | SetAlert(token, | otPlatAlarmMicroStartAt(otInstance |
| | Grpc | ALARM, | *aInstance, uint32_t aT0, |
| | AssistConfig: setText | scheduledTime . . .); | uint32_t aDt) -- Set the alarm to fire |
| | Query(“Set alarm | | at aDt microseconds after aT0. |
| | for <time>”) | | |
| Delete | EmbeddedAssistant | DeleteAlert(token) | otPlatAlarmMicroStop(otInstance |
| Alarm | Grpc | | *aInstance) |
| | AssistConfig: setText | | |
| | Query(“Cancel my | | |
| | alarm”) | | |
| Reminders | EmbeddedAssistant | SetAlert(token, | |
| | Grpc | REMINDER, | |
| | AssistConfig: setText | scheduledTime . . .); | |
| | Query(“Remind me | | |
| | about <event> at | | |
| | <time>”) | | |

The call-forwarding implementation module 370, which may be part of the remote computing device configuration module 365, may be configured to implement call-forward from the user equipment to the remote computing device. By way of non-limiting example, the processor (e.g., 210, 212, 214, 216, 218, 252, 260) of the user equipment may use one or more transceivers (e.g., 256) to transmit a call-forwarding registration request or similar message to a communication service provider (e.g., server 155) with instruction regarding where (i.e., what remote computing device) to which notifications should be forwarded.

Delegation message transmittal module 375, which may be also part of the remote computing device configuration module 365, may be configured to transmit a delegation message configured to cause the remote computing device to perform the notification function on behalf of the user equipment. By way of non-limiting example, the processor (e.g., 210, 212, 214, 216, 218, 252, 260) of the user equipment may use one or more transceivers (e.g., 256) to transmit a delegation message to a remote computing device (e.g., 120, 130, 140) with instructions regarding how, when, and/or under what circumstances the remote computing device notification functions should occur.

Revocation message transmittal module 380, which may further be part of the remote computing device configuration module 365, may be configured to transmit a revocation message to the remote computing device indicating the remote computing device should not perform the notification function on behalf of the user equipment. By way of non-limiting example, the processor (e.g., 210, 212, 214, 216, 218, 252, 260) of the user equipment may use one or more transceivers (e.g., 256) to transmit a revocation message to a remote computing device (e.g., 120, 130, 140) with instructions for the remote computing device to stop performing all or part of the remote computing device notification functions.

In some embodiments, the user equipment 110, remote computing devices 315, and/or external resources 320 may be operatively linked via a wireless network 125, 153. For example, the wireless network 125, 153 may be a cellular or Wi-Fi wireless local area network.

A given remote computing device 315 may include one or more processors configured to execute computer program modules similar to those in the machine-readable instructions 335 described above. By way of non-limiting examples, remote computing devices may include one or more of a desktop computer, a laptop computer, a handheld computer, a tablet computing platform, a NetBook, a Smartphone, a gaming console, and/or other computing platforms.

External resources 320 may include remote servers storing a contacts database (or a backup copy of a contacts database), sources of information outside of system 300, external entities participating with system 300, and/or other resources. In some embodiments, some or all of the functionality attributed herein to external resources 320 may be provided by resources included in system 300.

The processor(s) 330 may be configured to execute modules 340, 345, 350, 355, 360, 365, 370, 375, and/or 380, and/or other modules. Processor(s) 330 may be configured to execute modules 340, 345, 350, 355, 360, 365, 370, 375, and/or 380, and/or other modules by software; hardware; firmware; some combination of software, hardware, and/or firmware; and/or other mechanisms for configuring processing capabilities on processor(s) 330. As used herein, the term “module” may refer to any component or set of components that perform the functionality attributed to the module. This may include one or more physical processors during execution of processor readable instructions, the processor readable instructions, circuitry, hardware, storage media, or any other components.

The description of the functionality provided by the different modules 340, 345, 350, 355, 360, 365, 370, 375, and/or 380 described below is for illustrative purposes, and is not intended to be limiting, as any of modules 340, 345, 350, 355, 360, 365, 370, 375, and/or 380 may provide more or less functionality than is described. For example, one or more of modules 340, 345, 350, 355, 360, 365, 370, 375, and/or 380 may be eliminated, and some or all of its functionality may be provided by other ones of modules 340, 345, 350, 355, 360, 365, 370, 375, and/or 380. As another example, processor(s) 330 may be configured to execute one or more additional modules that may perform some or all of the functionality attributed below to one of modules 340, 345, 350, 355, 360, 365, 370, 375, and/or 380.

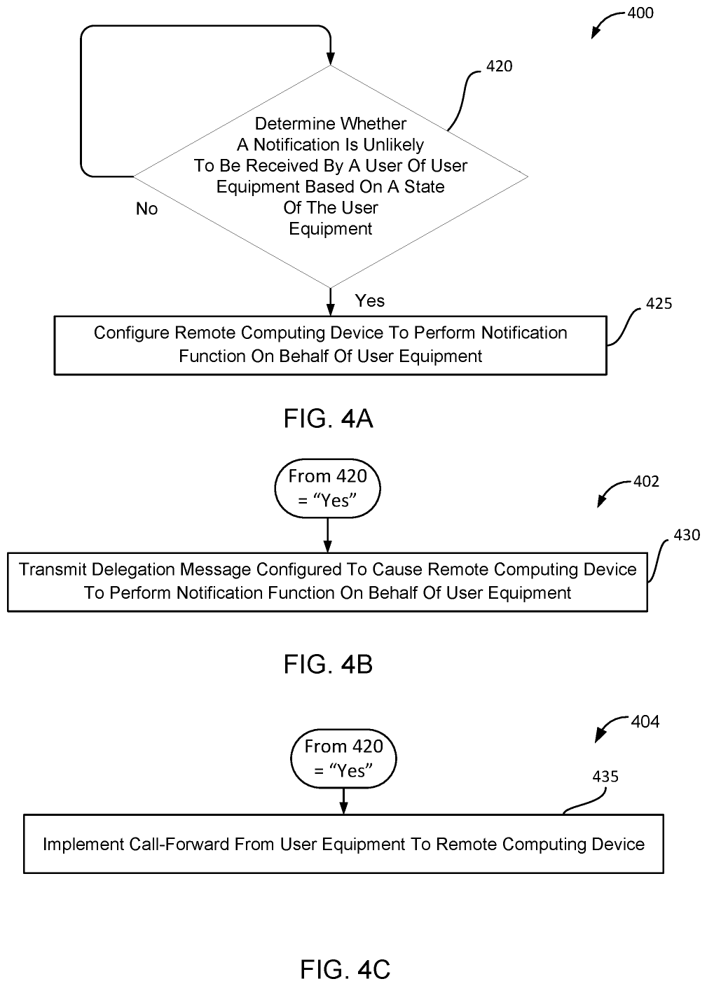

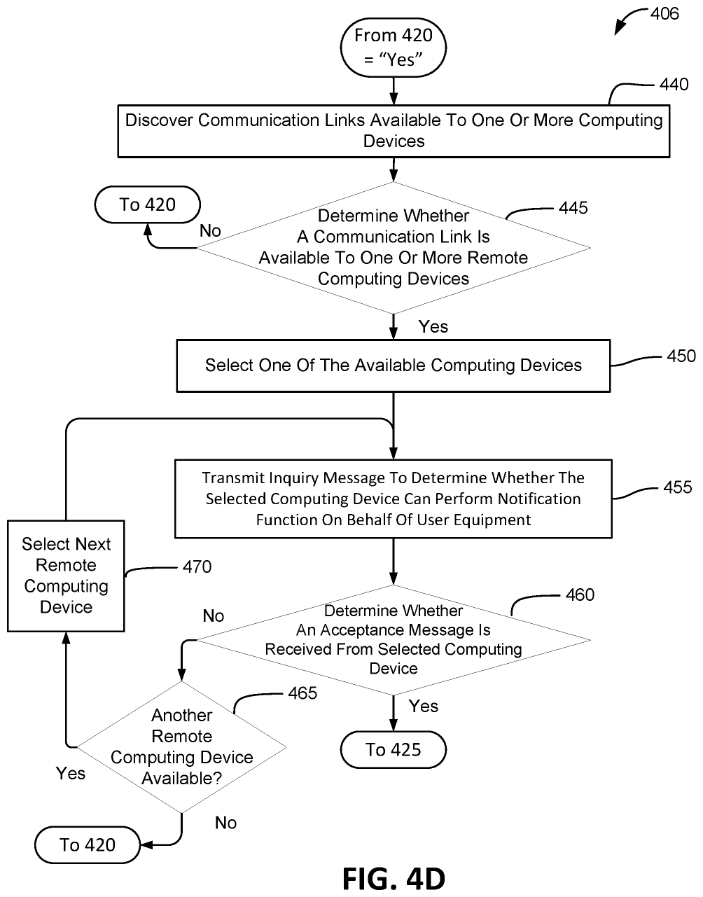

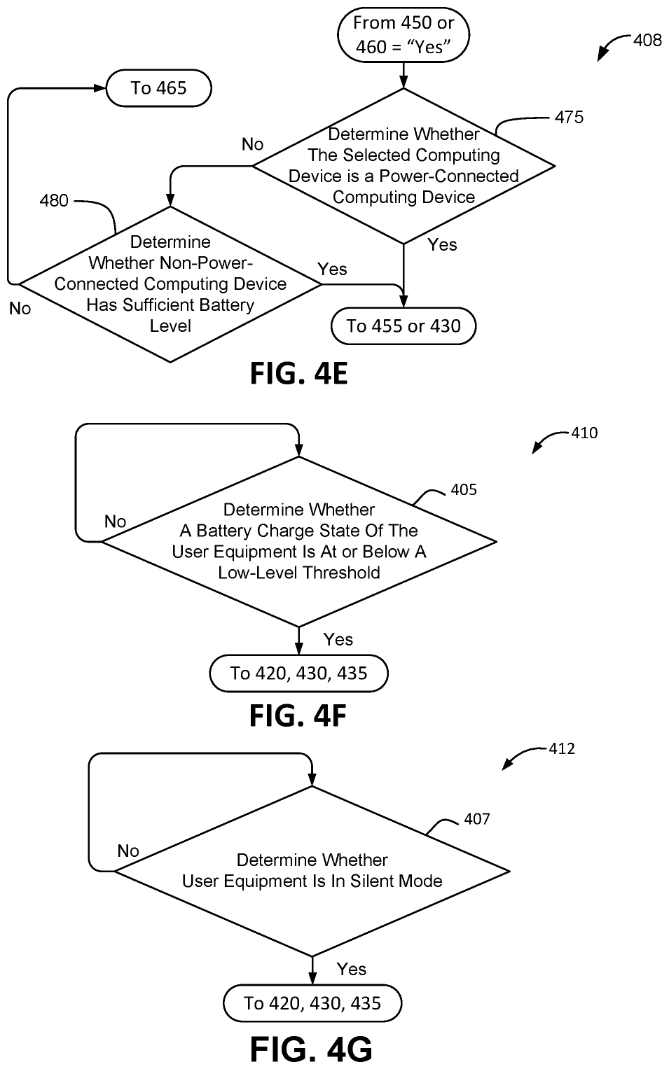

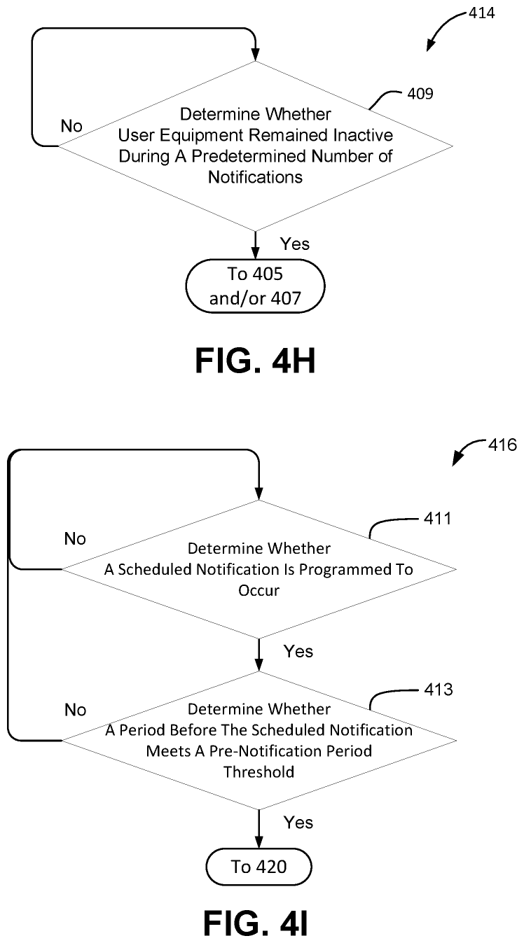

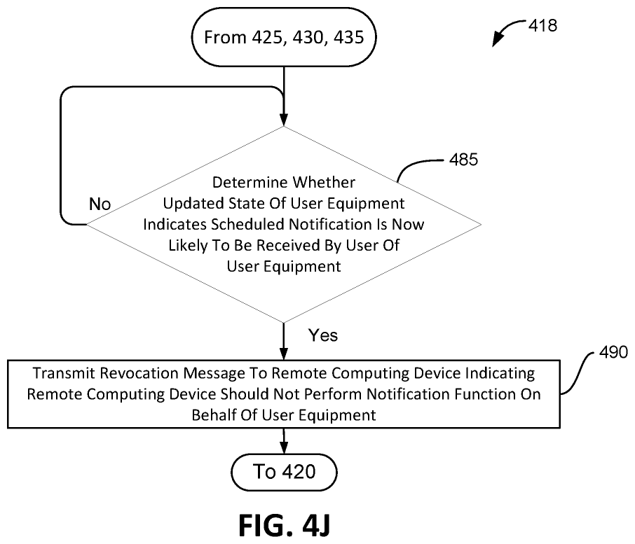

FIG. 4A illustrates a method 400 that may be executed by a processor of user equipment for ensuring a user receives notifications in accordance with various embodiments. FIGS. 4B, 4C, 4D, 4E, 4F, 4G, 4H, 4I, and/or 4J illustrate additional or alternative operations in methods 402, 404, 406, 408, 410, 412, 414, 416, and 418 that may be performed as part of the method 400 in some embodiments. With reference to FIGS. 1-4A, 4B, 4C, 4D, 4E, 4F, 4G, 4H, 4I, and/or 4J, the operations of the methods 400, 402, 404, 406, 408, 410, 412, 414, 416, and 418 presented below are intended to be illustrative. In some embodiments, methods 400, 402, 404, 406, 408, 410, 412, 414, 416, and 418 may be accomplished with one or more additional operations not described, and/or without one or more of the operations discussed. Additionally, the order in which the operations of the methods 400, 402, 404, 406, 408, 410, 412, 414, 416, and 418 are illustrated in FIGS. 4A, 4B, 4C, 4D, 4E, 4F, 4G, 4H, 4I, and/or 4J and described below is not intended to be limiting.

In various embodiments, the methods 400, 402, 404, 406, 408, 410, 412, 414, 416, and 418 may be implemented in one or more processors (e.g., 202, 204, 210, 212, 214, 216, 218, 252, 260) of user equipment (e.g., 110) configured with processor-executable instructions stored on an non-transitory processor-readable storage medium of. The one or more processors may include one or more devices configured through hardware, firmware, and/or software to be specifically designed for execution of one or more of the operations of the methods.

FIG. 4A illustrates a method 400 by which a processor of the user equipment may ensure a user receives notifications, in accordance with one or more embodiments.

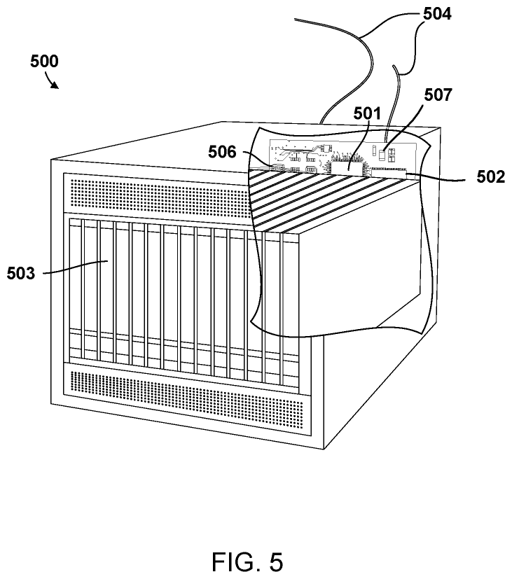

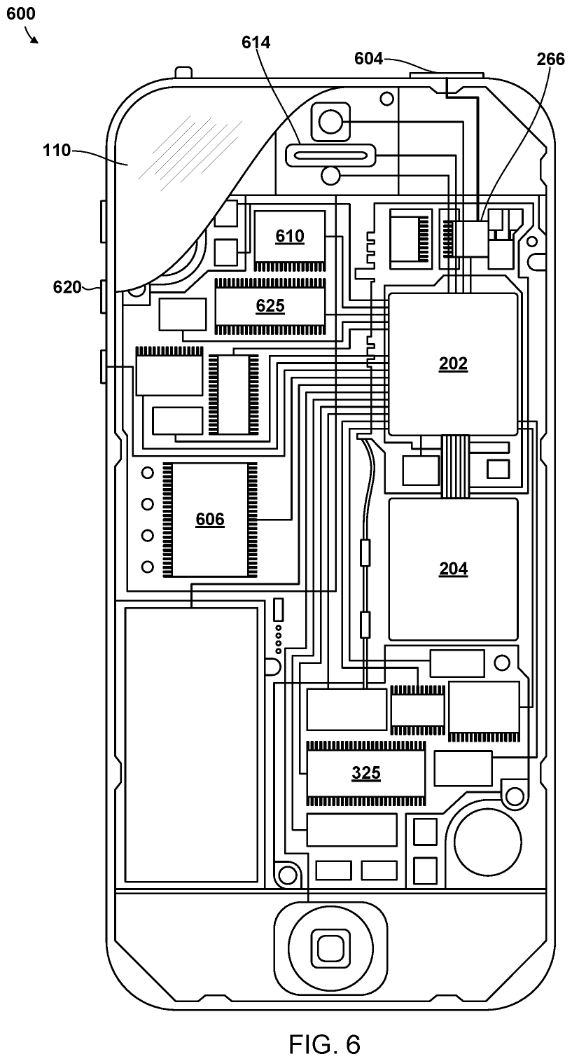

In determination block 420, the processor of the user equipment may perform operations including determining whether a notification is unlikely to be received by a user of the user equipment based on a state of the user equipment. To make the determination in determination block 420, the processor may use the user equipment state determination module (e.g., 340) to determine whether the state or states of the user equipment will impact whether any notification is likely or unlikely to be received by the user. Also, in determination block 420, the processor may access a database, containing one or more data records, stored in local memory (e.g., 220, 258) or from a remote source, such as a remote system (e.g., 315) or external resources (e.g., 320) using a transceiver (e.g., 256) and related components. The database may provide information as to which notification, if any, should be considered. In some embodiments, means for performing the operations of block 420 may include a processor (e.g., 202, 204, 210, 212, 214, 216, 218, 252, 260) coupled to a transceiver (e.g., 256) that is coupled to an antenna (504) (see, FIGS. 5 and 6, described in further detail below).

In response to determining that a notification is likely to be received by a user of the user equipment based on a state of the user equipment (i.e., determination block 420=“No”), the processor may repeat the operations in block 420 when and if the state of the user equipment or nature of notifications changes.

In response to determining that a notification is unlikely to be received by a user of the user equipment based on a state of the user equipment (i.e., determination block 420=“Yes”), the processor may perform operations including configuring a remote computing device to perform notification function on behalf of user equipment in block 425.

In block 425, the processor of the user equipment may perform operations including configuring a remote computing device to perform a notification function on behalf of the user equipment in response to determining that the notification is unlikely to be received by the user. To perform the operations in block 425, the processor may use at least one of the remote computing device configurations module 365, the call-forwarding implementation module 370, or the delegation message transmittal module 375. In block 425, the processor may convey APIs or instruct a remote computing device to provide warning sounds or other alerts that are associated with incoming calls, messages, alarms (e.g., timed alerts, calendar events, or other reminders), alerts (e.g., from applications), and/or assistant routines. In some embodiments, means for performing the operations of block 425 may include a processor (e.g., 202, 204, 210, 212, 214, 216, 218, 252, 260) coupled to a transceiver (e.g., 256) that is coupled to an antenna.

FIG. 4B illustrates a method 402 in which the processor configures the remote computing device to perform notification functions (i.e., block 425) by transmitting a delegation message to the remote computing device.

In response to determining that a notification is unlikely to be received (i.e., determination block 420=“Yes”), the processor of the user equipment may perform operations including transmitting a delegation message configured to cause the remote computing device to perform the notification function on behalf of the user equipment in block 430. To perform the operations in block 430, the processor may use the delegation message transmittal module 375. The delegation message(s) transmitted in block 430 may include the API's described above with regard to block 430. In some embodiments, means for performing the operations of block 430 may include a processor (e.g., 202, 204, 210, 212, 214, 216, 218, 252, 260) coupled to a transceiver (e.g., 256) that is coupled to an antenna (504) (see, FIGS. 5 and 6, described in further detail below).

FIG. 4C illustrates a method 404 in which the processor configures the remote computing device to perform notification functions (i.e., block 425) by implementing a call-forwarding function.

In response to determining that a notification is unlikely to be received (i.e., determination block 420=“Yes”), the processor of the user equipment may perform operations including implementing call-forward from user equipment to a remote computing device in block 435. To perform the operations in block 435, the processor may use the call-forwarding implementation module 370. In block 435, the processor may transmit a call-forwarding registration request or similar message to a communication service provider (e.g., server 155) with instruction regarding where (i.e., what remote computing device) to which notifications should be forwarded. In some embodiments, means for performing the operations of block 435 may include a processor (e.g., 202, 204, 210, 212, 214, 216, 218, 252, 260) coupled to a transceiver (e.g., 256) that is coupled to an antenna (504) (see, FIGS. 5 and 6, described in further detail below).

FIG. 4D illustrates a method 406 of further operations that may be performed by a processor of the user equipment to ensure a user receives notifications.

In response to determining that a notification is unlikely to be received (i.e., determination block 420=“Yes”), the processor of the user equipment may perform operations including discovering communication links available to one or more computing devices in block 440. To perform the operations in block 440, the processor may use the communication link determination module 350 and/or the inquiry transmittal module 355. In this regard, the process may attempt to discover all the available communication links to remote computing devices that might potentially be available to perform remote computing device notification functions. In particular, the processor may attempt to identify remote computing devices within the vicinity of the user equipment and is most likely to alert the user of a particular notification. For example, if the user is wearing a smart watch and the home network include a smart speaker, the processor may identify both those devices when discovering communication links. In some embodiments, means for performing the operations of block 440 may include a processor (e.g., 202, 204, 210, 212, 214, 216, 218, 252, 260) coupled to a transceiver (e.g., 256) that is coupled to an antenna.

In determination block 445, the processor of the user equipment may perform operations including determining whether a communication link is available to one or more remote computing devices. To perform the operations in determination block 445, the processor may use information discovered in block 440. In some embodiments, means for performing the operations of determination block 445 may include a processor (e.g., 202, 204, 210, 212, 214, 216, 218, 252, 260) coupled to a transceiver (e.g., 256) that is coupled to an antenna.

In response to determining that no communication link is available to one or more remote computing devices (i.e., determination block 445=“No”), the processor may repeat the operations in block 420 when and if the state of the user equipment or nature of notifications changes.

In response to determining that a communication link is available to one or more remote computing devices (i.e., determination block 445=“Yes”), the processor may perform operations including selecting one of the available remote computing devices in block 450.

In block 455, the processor of the user equipment may perform operations including transmitting an inquiry message to determine whether the selected computing device can perform notification function on behalf of user equipment. To perform the operations in block 455, the processor may use the inquiry transmittal module 355. The inquiry messages may be used to ensure at least one remote computing device is configured and able to perform the desired remote computing device notification function. In some embodiments, means for performing the operations of block 455 may include a processor (e.g., 202, 204, 210, 212, 214, 216, 218, 252, 260) coupled to a transceiver (e.g., 256) that is coupled to an antenna (504) (see, FIGS. 5 and 6, described in further detail below).

In determination block 460, the processor of the user equipment may perform operations including determining whether an acceptance message is received from a selected computing device. To perform the operations in determination block 460, the processor may use the response message receiving module (e.g., 360). The response message should indicate whether the remote computing device to which the inquiry message was transmitted, in block 455, has acknowledge and agrees to perform the desired remote computing device notification function. In some embodiments, means for performing the operations of determination block 460 may include a processor (e.g., 202, 204, 210, 212, 214, 216, 218, 252, 260) coupled to a transceiver (e.g., 256) that is coupled to an antenna (504) (see, FIGS. 5 and 6, described in further detail below).

In response to determining that no acceptance message is received from a selected computing device (i.e., determination block 460=“No”), the processor may determine whether another remote computing device is available to transmit another inquiry message in determination block 465.

In response to determining that an acceptance message is received from a selected computing device (i.e., determination block 460=“Yes”), the processor may perform operations including configuring a remote computing device to perform notification function on behalf of user equipment in block 425.

To perform the operations in determination block 465, the processor may use the results from determination block 445.

In response to determining that no other remote computing device is available to transmit another inquiry message (i.e., determination block 465=“No”), the processor may repeat the operations in block 420 when and if the state of the user equipment or nature of notifications changes.

In response to determining that another remote computing device is available to transmit another inquiry message (i.e., determination block 465=“Yes”), the processor may perform operations including selecting the next remote computing device in block 470 and then repeating the operations in block 455.

FIG. 4E illustrates a method 408 continuing operations of the method 406.

In response to determining that the selected computing device is a power-connected computing device (i.e., determination block 460=“Yes”), the processor of the user equipment may perform operations including determining whether the selected computing device (i.e., selected in blocks 450 or 470) is a power-connected computing device in determination block 475. To perform the operations in determination block 475, the processor may use information available from a database, containing one or more data records, stored in local memory (e.g., 220, 258) or from a remote source, such as a remote system (e.g., 315) or external resources (e.g., 320) using a transceiver (e.g., 256) and related components, to get information about the remote computing device(s) and whether they are power-connected computing devices. Some devices, like appliances and smart speakers may be specifically designated as power-connected computing devices. Alternatively, the processor may receive information from the response message receiving module 360, which may have been provided pertinent information directly from the respective remote computing device(s). In some embodiments, means for performing the operations of determination block 475 may include a processor (e.g., 202, 204, 210, 212, 214, 216, 218, 252, 260) coupled to a transceiver (e.g., 256) that is coupled to an antenna.

In response to determining that the selected computing device is not a power-connected computing device (i.e., determination block 475=“No”), the processor of the user equipment may perform operations including determining whether the selected computing device (i.e., selected in blocks 450 or 470), which is non-power-connected, has a sufficient battery level in determination block 480. To perform the operations in determination block 480, the processor may use information available from the selected computing device and/or a database containing one or more data records to obtain information about the remote computing device and whether that remote computing device has sufficient battery levels. The database may be stored in local memory (e.g., 220, 258) or obtained from or accessed via a remote source, such as a remote system (e.g., 315) or external resources (e.g., 320) using a transceiver (e.g., 256) and related components. For example, the processor may receive information from the database indicating the battery of the remote computing device may need to be charged to a requisite minimum level of battery charge (e.g., 10%-15%) before the remote computing device is considered to have sufficient battery level to be delegated responsibility to perform notification functions on behalf of the user equipment. The processor may receive information indicating the battery level of the remote computing device from the response message receiving module 360, which may have been provided pertinent information directly from the respective remote computing device(s). In some embodiments, means for performing the operations of determination block 475 may include a processor (e.g., 202, 204, 210, 212, 214, 216, 218, 252, 260) coupled to a transceiver (e.g., 256) that is coupled to an antenna.

In response to determining that the selected computing device, which is a non-power-connected computing device, does not have a sufficient battery level (i.e., determination block 480=“No”), the processor may perform the operations in block 465 to determine whether another remote computing device is available to transmit another inquiry message.

In response to determining that the selected computing device is a power-connected computing device (i.e., determination block 475=“Yes”) or in response to determining that the selected computing device, which is a non-power-connected computing device, has a sufficient battery level (i.e., determination block 480=“Yes”), the processor may perform operations including transmitting an inquiry message to determine whether the selected computing device can perform notification function on behalf of user equipment in block 455 or transmitting a delegation message configured to cause the remote computing device to perform the notification function on behalf of the user equipment in block 430.

FIG. 4F illustrates a method 410 by which a processor of the user equipment may determine that the user is unlikely to receive a notification in accordance with some embodiments.

In determination block 405, the processor of the user equipment may perform operations including determining whether a battery charge state of the user equipment is at or below low-level threshold. To perform the operations in determination block 405, the processor may use the user equipment state determination module 340. In some embodiments, means for performing the operations of determination block 405 may include a processor (e.g., 202, 204, 210, 212, 214, 216, 218, 252, 260) coupled to a transceiver (e.g., 256) that is coupled to an antenna.

In response to determining that the battery charge state of the user equipment is no at or below low-level threshold (i.e., determination block 405=“No”), the processor may repeat the operations in determination block 405 to determine whether a battery charge state of the user equipment is at or below low-level threshold.

In response to determining that the battery charge state of the user equipment is at or below low-level threshold (i.e., determination block 405=“Yes”), the processor may determine that a notification is unlikely to be received by a user of the user equipment and perform the operations to configure a remote computing device to perform the notification function in any of blocks 425, 430 or 435 as described.

FIG. 4G illustrates a method 412 by which a processor of the user equipment may determine that the user is unlikely to receive a notification in accordance with some embodiments.

In determination block 407, the processor of the user equipment may perform operations including determining whether user equipment is in a silent mode. To perform the operations in determination block 407, the processor may use the user equipment state determination module 340. In some embodiments, means for performing the operations of determination block 407 may include a processor (e.g., 202, 204, 210, 212, 214, 216, 218, 252, 260) coupled to a transceiver (e.g., 256) that is coupled to an antenna.

In response to determining that the user equipment is not in a silent mode (i.e., determination block 407=“No”), the processor may repeat the operations in determination block 407 to detect when the user equipment is placed in silent mode.

In response to determining that user equipment is in a silent mode (i.e., determination block 407=“Yes”), the processor may determine that a notification is unlikely to be received by a user of the user equipment and perform the operations to configure a remote computing device to perform the notification function in any of blocks 425, 430 or 435 as described.

FIG. 4H illustrates a method 414 by which a processor of the user equipment may determine that the user is unlikely to receive a notification in accordance with some embodiments.

In determination block 409, the processor of the user equipment may perform operations including determining whether the user equipment remained inactive during a predetermined number of notifications. To perform the operations in determination block 409, the processor may use the user equipment state determination module 340. To determine how long the user equipment has remained inactive, the processor may access a database, containing one or more data records, stored in local memory (e.g., 220, 258) or from a remote source, such as a remote system (e.g., 315) or external resources (e.g., 320) using a transceiver (e.g., 256) and related components. In some embodiments, means for performing the operations of determination block 409 may include a processor (e.g., 202, 204, 210, 212, 214, 216, 218, 252, 260) coupled to a transceiver (e.g., 256) that is coupled to an antenna.

In response to determining that the user equipment did not remain inactive during a predetermined number of notifications (i.e., determination block 409=“No”), the processor may repeat the operations in determination block 409 to determine whether the user equipment remained inactive during a predetermined number of notifications.

In response to determining that the user equipment remained inactive during a predetermined number of notifications (i.e., determination block 409=“Yes”), the processor may perform the operations including determining whether a battery charge state of the user equipment is at or below the low-level threshold in determination block 405 or determine whether the user equipment is in a silent mode in determination block 407.

FIG. 4I illustrates a method 416 by which a processor of the user equipment may ensure a user receives notifications, in accordance with one or more implementations.

In determination block 411, the processor of the user equipment may perform operations including determining whether a scheduled notification is programmed to occur. To perform the operations in determination block 411, the processor may use the notification determination module 345. To determine whether a scheduled notification if programmed to occur, the processor may access a database, containing one or more data records, stored in local memory (e.g., 220, 258) or from a remote source, such as a remote system (e.g., 315) or external resources (e.g., 320) using a transceiver (e.g., 256) and related components. In some embodiments, means for performing the operations of determination block 411 may include a processor (e.g., 202, 204, 210, 212, 214, 216, 218, 252, 260) coupled to a transceiver (e.g., 256) that is coupled to an antenna.

In response to determining that no scheduled notification is programmed to occur (i.e., determination block 411=“No”), the processor may repeat the operations in determination block 411 to determine whether or when a scheduled notification is programmed to occur.

In response to determining that a scheduled notification is programmed to occur (i.e., determination block 411=“Yes”), the processor may perform the operations including determining whether a period before the scheduled notification meets a pre-notification period threshold in determination block 413.

In response to determining that the period before the scheduled notification does not meet a pre-notification period threshold (i.e., determination block 413=“No”), the processor may repeat the operations in determination block 411 to determine whether or when a scheduled notification is programmed to occur.

In response to determining that the period before the scheduled notification meets a pre-notification period threshold (i.e., determination block 413=“Yes”), the processor may determine whether a notification is unlikely to be received by a user of the user equipment based on a state of the user equipment in determination block 420 as described.

FIG. 4J illustrates a method 418 by which a processor of the user equipment may revoke the delegation of the notification function, which may be performed after the operations in blocks 425, 430, or 435, or may be performed in a separate implementation.

In determination block 485, the processor of the user equipment may perform operations including determining whether an updated state of the user equipment indicates that a scheduled notification is now likely to be received by the user of the user equipment. To perform the operations in determination block 485, the processor may use the user equipment state determination module 340. For example, in determination block 485, the processor may determine that the user equipment has been plugged into a recharging power source, that a silence mode has been switched off, that user inputs have been received from the user (i.e., suggesting the user did receive the notification), that the notification is no longer applicable, or the like. In some embodiments, means for performing the operations of determination block 485 may include a processor (e.g., 202, 204, 210, 212, 214, 216, 218, 252, 260) coupled to a transceiver (e.g., 256) that is coupled to an antenna.

In response to determining that an updated state of the user equipment does not indicate that a scheduled notification is now likely to be received by the user of the user equipment (i.e., determination block 485=“No”), the processor may repeat the operations in determination block 485 to determine whether and when an updated state of the user equipment indicates that a scheduled notification is now likely to be received by the user of the user equipment.

In response to determining that an updated state of the user equipment indicates that a scheduled notification is now likely to be received by the user of the user equipment (i.e., determination block 485=“Yes”), the processor may perform operations including transmitting a revocation message to the remote computing device indicating that the remote computing device should not perform a notification function on behalf of user equipment in block 490, and, au again perform the operations in determination block 420 as described.

The various aspects (including, but not limited to, embodiments discussed above with reference to FIGS. 1-3) may be implemented on a variety of computing devices, an example of which is illustrated in FIG. 5 in the form of a server. With reference to FIGS. 1-5, the network computing device 500 may include a processor 501 coupled to volatile memory 502 and a large capacity nonvolatile memory, such as a disk drive 503. The network computing device 500 may also include a peripheral memory access device such as a floppy disc drive, compact disc (CD) or digital video disc (DVD) drive 506 coupled to the processor 501. The network computing device 500 may also include network access ports 504 (or interfaces) coupled to the processor 501 for establishing data connections with a network, such as the Internet and/or a local area network coupled to other system computers and servers. The network computing device 500 may include one or more antennas 507 for sending and receiving electromagnetic radiation that may be connected to a wireless communication link. The network computing device 500 may include additional access ports, such as USB, Firewire, Thunderbolt, and the like for coupling to peripherals, external memory, or other devices.

The various aspects (including, but not limited to, embodiments discussed above with reference to FIGS. 1-3) may be implemented on a variety of computing devices, an example of which is illustrated in FIG. 6 in the form of a mobile computing device. With reference to FIGS. 1-6, a mobile computing device 600 may include a first SoC 202 (e.g., a SoC-CPU) coupled to a second SoC 204 (e.g., a 5G capable SoC) and a third SoC 606 (e.g., a C-V2X SoC) A C-V2X SoC 606 may be configured for managing V2V, V2I, and V2P communications over D2D links, such as D2D links establish in the dedicated Intelligent Transportation Society (ITS) 5.9 GHz spectrum communications. The first, second, and/or third SoCs 202, 204, and 606 may be coupled to internal memory 325, 625, a display 110, and to a speaker 614. Additionally, the mobile computing device 600 may include one or more antenna 604 for sending and receiving electromagnetic radiation that may be connected to one or more transceiver 266 (e.g., a wireless data link and/or cellular transceiver, etc.) coupled to one or more processors in the first, second, and/or third SoCs 202, 204, and 606. Mobile computing devices 600 may also include menu selection buttons or rocker switches 620 for receiving user inputs.

Mobile computing devices 600 may additionally include a sound encoding/decoding (CODEC) circuit 610, which digitizes sound received from a microphone into data packets suitable for wireless transmission and decodes received sound data packets to generate analog signals that are provided to the speaker to generate sound. Also, one or more of the processors in the first, second, and/or third SoCs 202, 204, and 606, transceiver 266 and CODEC circuit 610 may include a digital signal processor (DSP) circuit (not shown separately).

The processors implementing various embodiments may be any programmable microprocessor, microcomputer or multiple processor chip or chips that can be configured by software instructions (applications) to perform a variety of functions, including the functions of the various aspects described in this application. In some communication devices, multiple processors may be provided, such as one processor dedicated to wireless communication functions and one processor dedicated to running other applications. Typically, software applications may be stored in the internal memory before they are accessed and loaded into the processor. The processor may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a processor of a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various aspects. Such services and standards may include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020™), EDGE, advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), integrated digital enhanced network (iden), C-V2X, V2V, V2P, V2I, and V2N, etc. Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various aspects illustrated and described are provided merely as examples to illustrate various features of the claims. However, features shown and described with respect to any given aspect are not necessarily limited to the associated aspect and may be used or combined with other aspects that are shown and described. Further, the claims are not intended to be limited by any one example aspect. For example, one or more of the operations of the methods may be substituted for or combined with one or more operations of the methods.

The foregoing method descriptions and the process flow diagrams are provided merely as illustrative examples and are not intended to require or imply that the operations of various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such aspect decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

1. A method executed by a processor of user equipment for ensuring a user receives notifications, comprising:
determining whether the user equipment received no user input during a predetermined number of notifications; and
configuring a remote computing device to perform a notification function on behalf of the user equipment in response to determining that user equipment received no user input during the predetermined number of notifications.

2. The method of claim 1, wherein configuring the remote computing device to perform a notification function on behalf of the user equipment comprises transmitting a delegation message configured to cause the remote computing device to perform the notification function on behalf of the user equipment.

3. The method of claim 1, wherein configuring the remote computing device to perform the notification function on behalf of the user equipment comprises implementing call-forwarding from the user equipment to the remote computing device.

4. The method of claim 1, further comprising:
determining whether a communication link is available to one or more remote computing devices in response to determining that the user equipment received no user input during the predetermined number of notifications;
transmitting an inquiry to determine whether a selected computing device can perform the notification function on behalf of the user equipment in response to determining that the communication link is available to one or more remote computing devices; and
receiving an acceptance message from the selected computing device indicating the selected computing device can perform the notification function on behalf of the user equipment,
wherein configuring the remote computing device to perform the notification function on behalf of the user equipment is performed further in response to receiving the acceptance message from the selected computing device.

5. The method of claim 4, further comprising determining whether the selected computing device is a power-connected computing device,
wherein configuring a remote computing device to perform a notification function on behalf of the user equipment in response to determining that the user equipment received no user input during the predetermined number of notifications comprises configuring the selected computing device to perform the notification function on behalf of the user equipment in response to determining that the user equipment received no user input during the predetermined number of notifications and that the selected computing device is a power-connected computing device.

6. The method of claim 4, further comprising determining whether the selected computing device has a battery level above a predetermined threshold,
wherein configuring a remote computing device to perform a notification function on behalf of the user equipment in response to determining that the user equipment received no user input during the predetermined number of notifications comprises configuring the selected computing device to perform the notification function on behalf of the user equipment in response to determining that the selected computing device has a battery level above the predetermined threshold.

7. The method of claim 1, further comprising:
determining whether a battery charge state of the user equipment is at or below a low-level threshold; and
determining that the notification will not be received by the user of the user equipment in response to determining that the battery charge state of the user equipment is at or below the low-level threshold.

8. The method of claim 1, further comprising:
determining whether the user equipment is in a silent mode; and
determining that the notification will not be received by the user of the user equipment in response to determining that the user equipment is in the silent mode.

9. (canceled)

10. The method of claim 1, further comprising determining whether the user equipment is within a pre-notification period before a scheduled notification,
wherein configuring the remote computing device to perform the notification function is performed further in response to determining that the user equipment is within the pre-notification period.

11. The method of claim 1, further comprising:
determining whether an updated state of the user equipment indicates the notification will be received by the user of the user equipment; and
transmitting a revocation message to the remote computing device indicating that the remote computing device should not perform the notification function on behalf of the user equipment in response to determining that the updated state of the user equipment indicates the notification will be received by the user of the user equipment.

12. A user equipment computing device, comprising:
a transceiver;
a memory, and
a processor coupled to the transceiver and the memory, and configured with processor-executable instructions to:
determine whether the user equipment computing device received no user input during a predetermined number of notifications; and
configure a remote computing device to perform a notification function on behalf of the user equipment computing device in response to determining that the user equipment computing device received no user input during the predetermined number of notifications.

13. The user equipment computing device of claim 12, wherein the processor is further configured with processor-executable instructions to configure the remote computing device to perform a notification function on behalf of the user equipment computing device by transmitting a delegation message configured to cause the remote computing device to perform the notification function on behalf of the user equipment computing device.

14. The user equipment computing device of claim 12, wherein the processor is further configured with processor-executable instructions to configure the remote computing device to perform the notification function on behalf of the user equipment computing device by implementing call-forwarding from the user equipment computing device to the remote computing device.

15. The user equipment computing device of claim 12, wherein the processor is further configured with processor-executable instructions to:
determine whether a communication link is available to one or more remote computing devices in response to determining that the user equipment computing device received no user input during the predetermined number of notifications;
transmit an inquiry to determine whether a selected computing device can perform the notification function on behalf of the user equipment computing device in response to determining that the communication link is available to one or more remote computing devices; and
receive an acceptance message from the selected computing device indicating the selected computing device can perform the notification function on behalf of the user equipment computing device,
wherein the processor is further configured with processor-executable instructions to configure the remote computing device to perform the notification function on behalf of the user equipment computing device further in response to receiving the acceptance message from the selected computing device.

16. The user equipment computing device of claim 15, wherein the processor is further configured with processor-executable instructions to determine whether the selected computing device is a power-connected computing device,
wherein the processor is further configured with processor-executable instructions to configure a remote computing device to perform a notification function on behalf of the user equipment computing device in response to determining that the user equipment computing device received no user input during the predetermined number of notifications and that the selected computing device is a power-connected computing device.

17. The user equipment computing device of claim 15, wherein the processor is configured with processor-executable instructions to perform operations further comprising determining whether the selected computing device has a battery level above a predetermined threshold,
wherein the processor is further configured with processor-executable instructions to configure a remote computing device to perform a notification function on behalf of the user equipment computing device in response to determining that the selected computing device has a battery level above the predetermined threshold.

18. The user equipment computing device of claim 12, wherein the processor is further configured with processor-executable instructions to:
determine whether a battery charge state of the user equipment computing device is at or below a low-level threshold; and
determine that the notification will not be received by the user of the user equipment computing device in response to determining that the battery charge state of the user equipment computing device is at or below the low-level threshold.

19. The user equipment computing device of claim 12, wherein the processor is further configured with processor-executable instructions to
determine whether the user equipment computing device is in a silent mode; and
determine that the notification will not be received by the user of the user equipment computing device in response to determining that the user equipment computing device is in the silent mode.

20. (canceled)

21. The user equipment computing device of claim 12, wherein the processor is further configured with processor-executable instructions to determine whether the user equipment computing device is within a pre-notification period before a scheduled notification,
wherein the processor is further configured with processor-executable instructions to configure the remote computing device to perform the notification function further in response to determining that the user equipment computing device is within the pre-notification period.

22. The user equipment computing device of claim 12, wherein the processor is further configured with processor-executable instructions to
determine whether an updated state of the user equipment computing device indicates the notification will be received by the user of the user equipment computing device; and
transmit a revocation message to the remote computing device indicating that the remote computing device should not perform the notification function on behalf of the user equipment computing device in response to determining that the updated state of the user equipment computing device indicates the notification will be received by the user of the user equipment computing device.

23. A non-transitory processor-readable medium having stored thereon processor-executable instructions configured to cause a processor of a user equipment computing device to perform operations, for maintaining an information interface for contact information, comprising:
determining whether the user equipment computing device received no user input during a predetermined number of notifications; and
configuring a remote computing device to perform a notification function on behalf of the user equipment computing device in response to determining that the user equipment computing device received no user input during the predetermined number of notifications.

24. The non-transitory processor-readable medium of claim 23, wherein the stored processor-executable instructions are configured to cause the processor of the user equipment computing device to perform operations such that configuring the remote computing device to perform a notification function on behalf of the user equipment computing device comprises transmitting a delegation message configured to cause the remote computing device to perform the notification function on behalf of the user equipment computing device.

25. The non-transitory processor-readable medium of claim 23, wherein the stored processor-executable instructions are configured to cause the processor of the user equipment computing device to perform operations such that configuring the remote computing device to perform the notification function on behalf of the user equipment computing device comprises implementing call-forwarding from the user equipment computing device to the remote computing device.

26. The non-transitory processor-readable medium of claim 23, wherein the stored processor-executable instructions are configured to cause the processor of the user equipment computing device to perform operations further comprising:
determining whether a communication link is available to one or more remote computing devices in response to determining that the user equipment computing device received no user input during the predetermined number of notifications;
transmitting an inquiry to determine whether a selected computing device can perform the notification function on behalf of the user equipment computing device in response to determining that the communication link is available to one or more remote computing devices; and
receiving an acceptance message from the selected computing device indicating the selected computing device can perform the notification function on behalf of the user equipment computing device,
wherein configuring the remote computing device to perform the notification function on behalf of the user equipment computing device is performed further in response to receiving the acceptance message from the selected computing device.

27. The non-transitory processor-readable medium of claim 26, further comprising determining whether the selected computing device is a power-connected computing device,
wherein configuring a remote computing device to perform a notification function on behalf of the user equipment computing device in response to determining that the user equipment computing device received no user input during the predetermined number of notifications comprises configuring the selected computing device to perform the notification function on behalf of the user equipment computing device in response to determining that the user equipment computing device received no user input during the predetermined number of notifications and that the selected computing device is a power-connected computing device.

28. The non-transitory processor-readable medium of claim 26, further comprising determining whether the selected computing device has a battery level above a predetermined threshold,
wherein configuring a remote computing device to perform a notification function on behalf of the user equipment computing device in response to determining that the user equipment computing device received no user input during the predetermined number of notifications comprises configuring the selected computing device to perform the notification function on behalf of the user equipment computing device in response to determining that the selected computing device has a battery level above the predetermined threshold.

29. The non-transitory processor-readable medium of claim 23, further comprising:
determining whether a battery charge state of the user equipment computing device is at or below a low-level threshold; and
determining that the notification will not be received by the user of the user equipment computing device in response to determining that the battery charge state of the user equipment computing device is at or below the low-level threshold.

30. A user equipment computing device, comprising:
means for determining whether the user equipment computing device received no user input during a predetermined number of notifications; and
means for configuring a remote computing device to perform a notification function on behalf of the user equipment computing device in response to determining that the user equipment computing device received no user input during the predetermined number of notifications.
